(19) United States
(12) Patent Application Publication
(10) Pub. No.: US 2023/0088454 A1
(43) Pub. Date: Mar. 23, 2023

(54) FLOOR FINISHING COMPOSITIONS WITH ENHANCED DURABILITY, METHODS OF MAKING AND USING THEREOF

(71) Applicant: Diversey, Inc., Fort Mill, SC (US)

(72) Inventors: David Mauer, Kenosha, WI (US); Steve Hodges, Twin Lakes, WI (US); Michael Sarkis, Racine, WI (US)

(21) Appl. No.: 17/802,240

(22) PCT Filed: Feb. 18, 2021
(86) PCT No.: PCT/IB2021/051387

§ 371 Date: Aug. 25, 2022

Related U.S. Application Data
(60) Provisional application No. 62/982,977, filed on Feb. 28, 2020.

(51) Int. Cl. C09D 133/10; C09D 7/61

(52) U.S. Cl. CPC C09D 133/10; C09D 7/61

(57) ABSTRACT

A floor finishing composition comprises water, polymer of ethylenic unsaturated monomers having a glass transition temperature of at least 90#C as measured using differential scanning calorimetry according to the ASTM Method D3418-15, coalescing solvent, and polyvalent metal crosslinking agent. The ethylenic unsaturated monomers comprise methyl (meth)acrylate, α,β-unsaturated carboxylic acid, aromatic vinyl monomer, and no more than 25% by weight of α,β-unsaturated carboxylic ester of C2-10 alcohol based on total weight of the monomers. The ethylenic unsaturated monomers may comprise from about 14% to about 18% by weight of the α,β-unsaturated carboxylic acid based on total weight of the monomers. The amount of coalescing solvent in the floor finishing composition may be more than 6% by weight based on total weight of the floor finishing composition.

This application claims priority to co-pending U.S. Provisional Application No. 62/982,977, filed on Feb. 28, 2020, which is incorporated herein by reference in its entirety.

### TECHNICAL FIELD

### Field of Invention

This disclosure relates to floor finishing compositions, and more particularly to water-based floor finishing compositions that, when applied to the floor, provide floor finishes with improved durability.

### Background

Floor finishing compositions are periodically applied to the floor to protect the surface and enhance the visual appearance. Installation of floor finish may be achieved by coating the floor with successive coats of the floor finishing compositions. Floor finish discolors over time while in service due to mechanical embedment of dry soil and color bodies absorbed into the floor finish film as carried by water (i.e., dirty water). Once such finish has become soiled or is otherwise in need of replacement, the finish is removed and reapplied. It is desirable to have a floor finish that takes more time for discoloration to reach a level that triggers the need for replacement (i.e., longer service life). The floor finish with improved durability reduces the labor and cost needed to remove the old finish from the floor and reapply the new finish.

Highly crosslinked polymer chemistry such as multi-component polyurethane and epoxy materials are used in floor finishing compositions to improve durability and extend the floor finish service life. However, multi-component polyurethane and epoxy floor finishes require special application skills as reactive systems. They have a relatively short application window of time or pot life and are understood as permanent coatings not easily removed chemically at the end of service life.

There is a need for floor finishing composition that provides floor finish with improved durability and longer service life to reduce the labor, cost, and business disruption associated with removing old floor finish and the reinstallation of a new finish.

### SUMMARY

In one aspect, a polymer of ethylenic unsaturated monomers is provided for use in floor finishing composition. The polymer includes units derived from ethylenic unsaturated monomers comprising methyl (meth)acrylate, α,β-unsaturated carboxylic acid, aromatic vinyl monomer, and no more than 25% by weight of α,β-unsaturated carboxylic ester of C2-10 alcohol based on total weight of the monomers. In some embodiments, such monomers include less than 25% by weight of the α,β-unsaturated carboxylic ester of C2-10 alcohol based on total weight of the monomers. In some embodiments, such monomers include from about 14% to about 18% by weight of the α,β-unsaturated carboxylic acid based on total weight of the monomers. In some embodiments, the polymer has a Tg of from about 90° C. to about 150° C., as measured using differential scanning calorimetry (DSC), according to the ASTM Method D3418-15.

In another aspect, a floor finishing composition is provided that comprises water, polymer of ethylenic unsaturated monomers having a Tg of at least 90° C. as measured using DSC according to the ASTM Method D3418-15, coalescing solvent, and a polyvalent metal crosslinking agent, wherein the ethylenic unsaturated monomers comprise methyl (meth)acrylate, α,β-unsaturated carboxylic acid, aromatic vinyl monomer, and no more than 25% by weight of α,β-unsaturated carboxylic ester of C2-10 alcohol based on total weight of the monomers. In some embodiments, such ethylenic unsaturated monomers comprise less than 25% by weight of the α,β-unsaturated carboxylic ester of C2-10 alcohol based on total weight of the monomers. In some embodiments, such ethylenic unsaturated monomers comprise from about 14% to about 18% by weight of the α,β-unsaturated carboxylic acid based on total weight of the monomers. In some embodiments, the polymer has a Tg of from about 90° C. to about 150° C. as measured using DSC according to the ASTM Method D3418-15. In certain embodiments, the coalescing solvent is present in an amount of at least 6% by weight based on total solid weight of the floor finishing composition.

In yet another aspect, a method of finishing floor is provided that comprises applying the aforementioned floor finishing composition to the floor.

Other aspects of the disclosure will become apparent by consideration of the detailed description.

### DETAILED DESCRIPTION

The present disclosure generally relates to a floor finishing composition that provides floor finish with improved durability and longer service life. The disclosed floor finishing composition utilizes a polymer having uniquely high glass transition temperature and more than a conventional concentration of coalescing solvents.

The terms “comprise(s),” “comprising,” “include(s),” “including,” “having,” “has,” “contain(s),” “containing,” and variants thereof, as used herein, are open-ended transitional phrases, terms, or words meant to encompass the items listed thereafter and equivalents thereof as well as additional items. The singular forms “a”, “and”, and “the” include plural references unless the context dictates otherwise. Where the term “comprising” is used, the present disclosure also contemplates other embodiments “comprising”, “consisting of”, or “consisting essentially of” elements presented herein, whether explicitly set forth or not.

Any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

The term “about,” as used herein, refers to variation in the numerical quantity that may occur, for example, through typical measuring and liquid handling procedures used for making concentrates or use solutions in the real world; through an inadvertent error in these procedures; through differences in the manufacture, source, or purity of the ingredients used to make the compositions or carry out the methods; and the like. The term “about” may refer to plus or minus 10% of a specified value. In some embodiments, the term “about” may refer to plus or minus 5% of a specified value. Other meanings of “about” may be apparent from the context, such as rounding off. So, for example, “about 1” may also mean from 0.5 to 1.4.

The term “substantially free”, “free”, “substantially no”, or “no” refers to a floor finishing composition or a polymer that does not contain a particular compound or to which a particular compound has not been added to the floor finishing composition or polymer. Should the particular compound be present through contamination, the amount of such particular compound shall be less than 1% by weight, preferably less than 0.5% by weight.

The term “coalescing solvent”, as used herein, refers to a fugitive coalescing agent that assists in the film formation of floor finish and is sufficiently volatile under the conditions employed to form a dry floor finish such that the coalescing solvent will be substantially removed from the floor finish. For example, coalescing solvent may remain in the floor finish within one day after installing the floor finishing composition to the floor. Still, it will not stay in the floor finish during service life. Non-limiting examples of coalescing solvents are glycol ethers such as ethylene glycol monomethyl ether, ethylene glycol monoethyl ether, ethylene glycol monobutyl ether, diethylene glycol monobutyl ether, diethylene glycol diethyl ether, and propylene glycol phenyl ether; and glycol ether acetates such as diethylene glycol monoethyl ether acetate, and ethylene glycol monomethyl ether acetate.

The term “glass transition temperature” or “Tg”, as used herein, refers to a temperature that polymer changes from a rigid glassy material to a soft (not melted) material. In the present disclosure, the Tg of polymer is measured using differential scanning calorimetry (DSC) according to the ASTM Method D3418-15.

In one aspect, a polymer of ethylenic unsaturated monomers is provided for use in floor finishing composition. The polymer has a glass transition temperature (Tg) of at least 90° C. as measured using differential scanning calorimetry (DSC) according to the ASTM Method D3418-15 (hereinafter “high Tg polymer”).

In some embodiments, the high Tg polymer has a Tg of at least 90° C. as measured using DSC according to the ASTM Method D3418-15. In some embodiments, the high Tg polymer has a Tg of from about 90° C. to about 150° C. as measured using DSC according to the ASTM Method D3418-15. In further embodiments, the high Tg polymer has a Tg of at least 90° C., 95° C., 97° C., 100° C., 105° C., 110° C., 115° C. as measured using DSC according to the ASTM Method D3418-15; and/or no more than 150° C., 145° C., 140° C., 135° C., 130° C., 128° C., 125° C., 120° C., 115° C., 110° C., 105° C., 100° C. as measured using DSC according to the ASTM Method D3418-15.

If the polymer has a Tg of lower than 90° C. as measured using DSC according to the ASTM Method D3418-15, the floor finishing composition formulated therefrom will exhibit inferior durability and have higher tendencies to become darker with gray discoloration. In other words, the floor finishing composition prepared from the polymer having a Tg of lower than 90° C. provides a shorter service life as compared to the floor finishing composition formulated from the disclosed high Tg polymer.

In some embodiments, the high Tg polymer includes units derived from ethylenic unsaturated monomers comprising methyl (meth)acrylate, α,β-unsaturated carboxylic acid, aromatic vinyl monomer, and no more than 25% by weight of α,β-unsaturated carboxylic ester of C2-10 alcohol based on total weight of the monomers. In some embodiments, the ethylenic unsaturated monomers include less than 25% by weight of the α,β-unsaturated carboxylic ester of C2-10 alcohol based on total weight of the monomers. In some embodiments, the high Tg polymer includes from about 14% to about 18% by weight of the α,β-unsaturated carboxylic acid based on total weight of the monomers.

Methyl (Meth)Acrylate Monomer

The term “methyl (meth)acrylate” used herein refers to methyl methacrylate, methyl acrylate, or a mixture thereof.

In some embodiments, the high Tg polymer includes units derived from the ethylenic unsaturated monomers comprising from about 15% to about 55% by weight of the methyl (meth)acrylate based on total weight of the monomers.

In some embodiments, the high Tg polymer includes units derived from the ethylenic unsaturated monomers comprising at least 15%, at least 20%, at least 24%, at least 30%, at least 35%, at least 40% by weight of the methyl (meth)acrylate based on total weight of the monomers; and/or no more than 24%, no more than 26%, no more than 30%, no more than 35%, no more than 40%, no more than 46%, no more than 50%, no more than 55% by weight of the methyl (meth) based on total weight of the monomers.

α,β-Unsaturated Carboxylic Acid Monomer

Suitable α,β-unsaturated carboxylic acid monomers include, but are not limited to, (meth)acrylic acid, maleic acid, fumaric acid, aconitic acid, crotonic acid, citraconic acid, acryloxypropionic acid, or any mixture thereof. Preferred α,β-unsaturated carboxylic acid monomer is methacrylic acid or acrylic acid. The α,β-unsaturated carboxylic acid monomers may be used singly or in a combination of two or more.

The term “(meth)acrylic acid” used herein refers to methacrylic acid, acrylic acid, or a mixture thereof.

In some embodiments, the high Tg polymer may include from about 14% to about 18% by weight of the α,β-unsaturated carboxylic acid based on total weight of the monomers. In some embodiments, the high Tg polymer may include from about 14% to about 16% by weight of the α,β-unsaturated carboxylic acid based on total weight of the monomers. In some embodiments, the high Tg polymer may include about 16% by weight of the α,β-unsaturated carboxylic acid based on total weight of the monomers.

When the high Tg polymer includes less than 14% by weight of the α,β-unsaturated carboxylic acid, the floor finish derived therefrom may lose strip-ability, which is an ability to be chemically removed with floor finish stripper. If the high Tg polymer includes more than 18% by weight of the α,β-unsaturated carboxylic acid, floor finish resistance toward chemical and water may be compromised.

Aromatic Vinyl Monomer

Examples of suitable aromatic vinyl monomers include, but are not limited to, styrene, α-methylstyrene, β-methylstyrene, vinyl toluene, 1-vinyl naphthalene, 1-methylstyrene, 2-methylstyrene, 3-methylstyrene, 3,4-dimethylstyrene, 4-ethylstyrene, 2-chlorostyrene, 3-chlorostyrene, 1-bromostyrene, 2-bromostyrene, 4-chloro-3-methylstyrene, 4-t-butylstyrene, 2,4-dichlorostyrene, 2,6-dichlorostyrene, 1-methoxystyrene, 2-methoxystyrene, 4-methoxystyrene, allyl phenyl ether, or allyl tolyl ether. Styrene is the preferred aromatic vinyl monomer. The aromatic vinyl monomer may be used singly or in a combination of two or more.

In some embodiments, the high Tg polymer includes from about 30% to about 50% by weight of the aromatic vinyl monomer based on total weight of the monomers. In some embodiments, the high Tg polymer includes about 40% by weight of the aromatic vinyl monomer based on total weight of the monomers. In some embodiments, the high Tg polymer includes at least 30%, at least 35%, 40%, 45%; and/or no more than 50%, 45%, 40% by weight of the aromatic vinyl monomer based on total weight of the monomers.

α,β-Unsaturated Carboxylic Ester of C2-10 Alcohol Monomer

The high Tg polymer may include no more than 25% by weight of α,β-unsaturated carboxylic ester of C2-10 alcohol based on total weight of the monomers. In some embodiments, the high Tg polymer may include less than 25% by weight of α,β-unsaturated carboxylic ester of C2-10 alcohol based on total weight of the monomers.

Non-limiting examples of α,β-unsaturated carboxylic ester of C2-10 alcohol are methyl (meth)acrylate, ethyl (meth)acrylate, n-propyl (meth)acrylate, iso-propyl (meth)acrylate, n-butyl (meth)acrylate, iso-butyl (meth)acrylate, t-butyl (meth)acrylate, n-amyl (meth)acrylate, iso-amyl (meth)acrylate, hexyl (meth)acrylate, cyclohexyl (meth)acrylate 2-ethyl hexyl (meth)acrylate, n-octyl methacrylate, iso-nonyl (meth)acrylate, decyl (meth)acrylate. The α,β-unsaturated carboxylic ester of C2-10 alcohol monomer may be used singly or in combination of two or more.

The term “(meth)acrylate” used herein refers to methacrylate, acrylate, or a mixture thereof.

In some embodiments, the high Tg polymer includes units derived from the ethylenic unsaturated monomers comprising:

from about 15% to about 55% by weight of the methyl (meth)acrylate;

from about 14% to about 18% by weight of the α,β-unsaturated carboxylic acid;

from about 30% to about 50% by weight of the aromatic vinyl monomer, and

no more than 25% or less than 25% by weight of the α,β-unsaturated carboxylic ester of C2-10 alcohol, all based on total weight of the monomers.

In some embodiments, the ethylenic unsaturated monomers do not include (i.e., substantially free of) polyfunctional monomer such as an ethylenic unsaturated monomer having at least one acetoacetate group, an ethylenic unsaturated monomer having at least one epoxy group, an ethylenic unsaturated monomer having two or more ethylenically unsaturated groups; phosphoethyl (meth)acrylate; itaconic acid; (meth)acrylonitrile; vinyl ether; vinyl thiol; vinyl acetate; hydroxyalkyl (meth)acrylate; or any mixture thereof.

Any means of conventional emulsion or suspension polymerization may be used to prepare the high Tg polymer. The process for the preparation of the disclosed polymer is well known in the art. See, e.g., D. C. Blackley, Emulsion Polymerization (Wiley, 1975). Conventional dispersants may be used at levels ranging from about 0.1% to about 6% by weight based on total weight of the monomers. The initiation can be either by thermal or redox initiation. For thermal initiation, a polymerization initiator of the free radical type, such as ammonium or potassium persulphate, may be used alone or in conjunction with an accelerator, such as potassium metabisulphate or sodium thiosulphate. The initiator and accelerator may be used in proportions of 0.5% to 2% based on the total weight of monomers to be copolymerized. For redox initiation, conventional free radical initiators, such as hydrogen peroxide, organic hydroperoxides, organic peroxides, and inorganic peroxides, may be used at levels of 0.05% to 3% based on total weight of the monomers on the monomers' total weight. The polymerization temperature may, for example, be from room temperature to 90° C. or more. Chain transfer agents such as mercaptans, polymercaptans, and polyhalogen compounds, may be used in the polymerization mixture to control polymer molecular weight. Furthermore, a plasticizer may or may not be included in the polymerization mixture.

The high Tg polymer may be obtained in the form of an aqueous emulsion. In some embodiments, the high Tg polymer is in a form of an aqueous emulsion having % solids ranging from about 20% to about 60%. In some embodiments, % solids of the high Tg polymer in the aqueous emulsion is at least 20%, at least 25%, at least 30%, at least 35%, at least 40%, at least 45%, at least 50%%, at least 55%; and/or no more than 60%, no more than 55%, no more than 50%, no more than 45%, no more than 40%, no more than 35%, no more than 30%.

Floor Finishing Composition

The floor finishing composition may comprise:
water;
polymer of ethylenic unsaturated monomers having a glass transition temperature (Tg) of at least 90° C. as measured using differential scanning calorimetry (DSC) according to the ASTM Standard Method D3418-15, wherein the ethylenic unsaturated monomers comprise methyl (meth)acrylate, α,β-unsaturated carboxylic acid, aromatic vinyl monomer, and no more than 25% or less than 25% by weight of α,β-unsaturated carboxylic ester of C2-10 alcohol based on total weight of the monomers;
coalescing solvent; and
polyvalent metal crosslinking agent.

In some embodiments, the floor finishing composition comprises the coalescing solvent in an amount of at least 6%, preferably from about 6% to about 12%, by weight based on total weight of the floor finishing composition.

In some embodiments, the floor finishing composition may be substantially free of polyurethane and/or polyepoxy.

The floor finishing composition may have a pH of from about 6 to about 10.

The floor finishing composition may have a % solids content of about 10% to about 30%.

High Tg Polymer

The high Tg polymer may be present in the floor finishing composition in proportions ranging from about 5% to about 35% by weight polymer solids based on total weight of the floor finishing composition.

In some embodiments, the floor finishing composition comprises at least 5%, at least 10%, at least 15%, at least 20%, at least 25%, at least 30%; and/or no more than 35%, no more than 30%, no more than 25%, no more than 20%, no more than 15% by weight polymer solids based on total weight of the floor finishing composition.

Coalescing Solvent

Suitable coalescing solvents may include, but not limited to, alcohols such as ethanol, isopropyl alcohol, ethylene glycol; glycol ethers such as diethylene glycol monomethyl ether, diethylene glycol monoethyl ether, dipropylene glycol monomethyl ether, dipropylene glycol monoethyl ether, ethylene glycol mono-2-methyl hexyl ether, and diethylene glycol mono-2-ethyl hexyl ether; glycol ether esters; ester alcohols; or any mixture thereof. The coalescing solvent may be used singly or in a combination of two or more.

Non-limiting examples of the preferred coalescing solvents are diethylene glycol monoethyl ether (such as Eastman™ DE solvent), dipropylene glycol monoethyl ether (such as DPGEE solvent commercially available from Shell Chemicals), dipropylene glycol monomethyl ether (such as Dowanol™ DPM solvent), ethylene glycol 2-ethylhexyl ether (such as Eastman™ EEH solvent), diethylene glycol n-propyl ether (such as Eastman DP™ solvent).

In some embodiments, the coalescing solvent comprises diethylene glycol monoethyl ether, diethylene glycol n-propyl ether, ethylene glycol 2-ethylhexyl ether, or any mixtures thereof.

The term “volatile organic compounds” or “VOC”, as used herein, refers to the organic compounds that have a high vapor pressure (e.g., evaporate into the air) at room temperature.

The term “low VOC”, as used herein, means a total level of volatile organic compounds in the floor finishing composition of less than 15%, preferably less than 10%, and most preferably less than 8% by weight based on the total solids weight of the floor finishing composition.

The floor finishing composition with a high VOC level presents regulatory and environmental concerns. Therefore, conventional floor finishing composition has a VOC content of less than 6% by weight based on total weight of the floor finishing composition. In contrast, the amount of coalescing solvent in the disclosed floor finishing composition may be at least 6% by weight. The amount of the coalescing solvent at lower than 6% by weight may result in an unacceptable film formation of the floor finishing composition on the flooring substrate.

In some embodiments, the amount of coalescing solvent in the floor finishing composition is at least 6% by weight based on total weight of the floor finishing composition. In some embodiments, the amount of coalescing solvent is from about 6% to about 12% by weight based on total weight of the floor finishing composition. In some embodiments, the amount of coalescing solvent is from about 7% to about 8% by weight based on total weight of the floor finishing composition. In certain embodiments, the amount of coalescing solvent is about 8% by weight based on total weight of the floor finishing composition.

In some embodiments, the amount of coalescing solvent is at least 6%, 7%, 8%, 9%, 10% by weight based on total weight of the floor finishing composition; and/or no more than 14%, 13%, 12%, 11% by weight based on total weight of the floor finishing composition.

Polyvalent Metal Crosslinking Agent

Polyvalent metal crosslinking agent refers to a crosslinking agent containing at least one polyvalent metal. Polyvalent metal refers to bivalent or higher valence metals, such as zinc, manganese, copper, cadmium, lead, bismuth, barium, antimony, chromium, zirconium, cobalt, nickel, tin, tungsten, aluminum, beryllium, magnesium, calcium, strontium, iron, etc.

Any known polyvalent metal crosslinking agents may be used in the present disclosure. Non-limiting examples of suitable polyvalent metal crosslinking agents are zinc ammonium carbonate, cadmium ammonium glycinate, nickel ammonium glycinate, zinc ammonium glycinate, zirconium ammonium glycinate, zinc ammonium alanate, copper ammonium β-alanate, zinc ammonium β-alanate, zinc ammonium valanate, and copper bis-dimethylaminoacetate. The preferred polyvalent metal crosslinking agent is zinc ammonium carbonate.

The amount of polyvalent metal crosslinking agent in the disclosed floor finishing composition is a function of the α,β-Unsaturated carboxylic acid monomer unit in the high Tg polymer. In some embodiments, the polyvalent metal crosslinking agent is present in a range of from about 10% to about 100%, preferably from about 30% to about 100%, theoretical mole stoichiometry based on the α,β-Unsaturated carboxylic acid monomer unit in the high Tg polymer.

In some embodiments, the floor finishing composition comprises:
water;
polymer of ethylenic unsaturated monomers having a glass transition temperature of at least 90° C. as measured using differential scanning calorimetry (DSC) according to the ASTM Standard Method D3418-15, in an amount of from about 5% to about 35% by weight polymer solids based on total weight of the floor finishing composition, wherein the ethylenic unsaturated monomers comprise methyl (meth)acrylate, α,β-unsaturated carboxylic acid, aromatic vinyl monomer, and no more than 25% or less than 25% by weight of α,β-unsaturated carboxylic ester of C2-10 alcohol based on total weight of the monomers;
coalescing solvent in an amount of at least 6% by weight based on total weight of the floor finishing composition; and
polyvalent metal crosslinking agent in a range of from about 10% to about 100%, preferably from about 30% to about 100%, theoretical mole stoichiometry based on the α,β-Unsaturated carboxylic acid monomer unit on the polymer.

In some embodiments, the aforementioned high Tg polymer in the floor finishing composition is a polymer of ethylenic unsaturated monomers comprising:

from about 15% to about 55% by weight of the methyl (meth)acrylate;

from about 14% to about 18% by weight of the α,β-unsaturated carboxylic acid;

from about 30% to about 50% by weight of the aromatic vinyl monomer, and

no more than 25% or less than 25% by weight of the α,β-unsaturated carboxylic ester of C2-10 alcohol, all based on total weight of the monomers.

The disclosed floor finishing composition may further comprise plasticizer, alkaline soluble resin, wax, surfactant, dispersing agent, wetting agent, leveling agent, coating slip aid, defoamer, preservative, biocide, or any combinations thereof.

Plasticizer increases the plasticity or fluidity of the floor finishing composition. As a result, a relatively high level of plasticizer may result in a soft floor finish. Alternatively, a relatively low level of plasticizer may create a brittle floor finish. In some embodiments, the floor finishing composition may contain plasticizer in an amount ranging from about 0.5% to about 5% by weight based on total weight of the floor finishing composition. Non-limiting examples of plasticizers may include benzoate ester such as diethylene glycol monobenzoate, triethylene glycol monobenzoate, dipropylene glycol monobenzoate; tributoxyethyl phosphate; glycol ether dibenzoates such as propylene glycol dibenzoate, dipropylene glycol dibenzoate, polypropylene glycol dibenzoate, ethylene glycol dibenzoate, diethylene glycol dibenzoate, polyethylene glycol dibenzoate, neopentyl glycol dibenzoate; 2,2,4-trimethyl-1,3-pentanediol diisobutyrate; dibutyl phthalate; dioctyl phthalate; caprolactam; or any combination thereof.

The floor finishing composition may contain one or more polyalkene wax such as, but is not limited to, polyethylene waxes, oxidized polyethylene waxes, polypropylene waxes, oxidized polypropylene waxes, waxes based on copolymers of propylene and acrylic acid, and/or methacrylic acid, and/or maleic anhydride, waxes based on copolymers of ethylene and acrylic esters and/or maleic anhydride, waxes based on copolymers of ethylene and acrylic acid and/or methacrylic acid and/or maleic anhydride, waxes based on copolymers of ethylene and styrene and/or other vinyl monomers.

Generally, the floor finishing compositions may have a % solid content of about 10% to about 30%. The pH of floor finishing compositions may be from about 6 to about 10.

Method of Finishing the Floor

The method of finishing the floor comprises applying the disclosed floor finishing composition to the floor surface. Typically, six coats of floor finishing composition are required to achieve the floor finish with desired levels of protection and appearance for the floor. The first coat of floor finishing composition is applied to the floor surface and then allowed to dry before applying the second coat of floor finishing composition. Generally, a drying time of about 20 minutes to about 60 minutes is allowed before a successive coat of floor finishing composition is applied.

The floor finishing composition may be applied to the floor using any known techniques, including a mop such as string mop, or other floor finish applicators such as Prospeed® floor finish Applicator System commercially available from Diversey, Inc.

Generally, there are two groups of flooring types: hard (stone) floors and resilient floors. The disclosed floor finishing composition is suitable for both flooring types. Non-limiting examples of the suitable floor are wood flooring, rubber tile, rubber sheet, cork, vinyl tile, vinyl sheet, linoleum, stone flooring, ceramic, terrazzo, and concrete.

In certain embodiments, the method of finishing the floor comprises applying the disclosed floor finishing composition to a resilient floor. Examples of suitable resilient floors include, but are not limited to, vinyl composition tile (VCT), luxury vinyl tile, vinyl tile, vinyl sheet, linoleum, rubber tile, rubber sheet, wood flooring, PVC flooring, cork flooring, and laminate.

It is well-recognized by a person of ordinary skill in the art that a polymer used in floor finishing composition should have Tg of no more than 80° C. as measured using DSC according to the ASTM Method D3418-15. The polymer having a Tg of greater than 80° C. may result in a floor finishing composition that has poor film-forming and is too brittle.

The disclosed floor finishing composition utilizes a polymer having Tg of at least 90° C. as measured using DSC according to the ASTM Method D3418-15, which is at least 13% higher than the conventional Tg range of polymer commonly used. Surprisingly and unexpectedly, the floor finish derived from the disclosed floor finishing composition has improved durability (e.g., excellent color retention) and yet provides good film-forming properties and strippability. See EXAMPLES 3 to 5. In addition, after the application of floor finishing composition to the floor surface, the polyvalent metal and the carboxylic acid moieties of the high Tg polymer react during the drying process through a polyvalent metal crosslinking mechanism, resulting in the further enhanced durability of the floor finish.

The following non-limiting examples illustrate the floor finishing compositions of the present disclosure and methods of use thereof.

### EXAMPLES

Abbreviations

MMA Methyl methacrylate

TBMA t-Butyl methacrylate

IBMA Iso-butyl methacrylate

MAA Methacrylic acid

DP Diethylene glycol propyl ether

DPM Dipropylene glycol methyl ether

EEH Ethylene glycol 2-ethyl hexyl ether

### Example 1

Preparation of High Tg Polymers

Four high Tg polymers were prepared. Polymer #1 was prepared by the following procedure: About 1887.0 grams (g) of deionized water, 38.4 g of polyoxyethylene tridecyl ether phosphate surfactant (Rhodafac® RS-410 from Solvay S.A.), and 8.89 g of 50% sodium hydroxide solution were charged to a reactor, and heated to 85° C. under nitrogen and agitation at about 185-190 rpm. Then, an ammonium persulfate solution (8.96 g dissolved in 35.8 g of deionized water) was added. A homogeneous mixture of ethylenic unsaturated monomers was prepared that comprised 40% by weight of styrene, 30% by weight of MMA, 14% by weight of IBMA, and 16% by weight of MAA, each based on total weight of the monomers. After holding for 3 minutes, the homogeneous mixture of ethylenic unsaturated monomers (totaled 1369.6 g) was fed to the reactor for 75 minutes while maintaining the reaction temperature at 85° C. After completing the monomer feed, the reactor was charged with 272.8 g of deionized water, and the polymerization reaction temperature was held at 85° C. for 90 minutes. At the end of the 90-minute hold, the reaction mixture was cooled down to 50° C. A solution of ammonium hydroxide (51.2 g of deionized water and 5.12 g of 28% ammonium hydroxide solution) was fed to the reactor over 5 minutes while the reactor was allowed to cool down to room temperature.

Polymers #2 was prepared by the following procedure: About 1887 g of deionized water, 8.89 g of 50% sodium hydroxide solution, and 38.4 g of polyoxyethylene tridecyl ether phosphate surfactant (Rhodafac® RS-410 from Solvay S.A.) were charged to a reactor and heated to 85° C. under nitrogen and agitation at about 185-190 rpm. Then, an ammonium persulfate solution (8.96 g dissolved in 35.8 g of deionized water) was added. A homogeneous mixture of ethylenic unsaturated monomers was prepared that comprised 40% by weight of styrene, 30% by weight of MMA, 14% by weight of IBMA, and 16% by weight of MAA, each based on total weight of the monomers. After holding for 3 minutes, the homogeneous mixture of ethylenic unsaturated monomers (totaled 1369.6 g) and 89.6 g of plasticizer (Benzoflex™ 2088 benzoate ester from Eastman Chemical Company) was fed to the reactor for 75 minutes while maintaining the reaction temperature at 85° C. After completing the monomer feed, the reactor was charged with 272.8 g of deionized water, and the polymerization reaction temperature was held at 85° C. for 90 minutes. At the end of the 90-minute hold, the reaction mixture was cooled down to 50° C. A solution of ammonium hydroxide (51.2 g of deionized water and 5.12 g of 28% ammonium hydroxide solution) was fed to the reactor over 5 minutes while the reactor was allowed to cool down to room temperature.

Polymer #3 was prepared using the same procedure as Polymer #2, but the homogeneous mixture of ethylenic unsaturated monomers for Polymer #3 comprised 40% by weight of styrene, 26% by weight of MMA, 20% by weight of TBMA, and 14% by weight of MAA, each based on total weight of the monomers.

Polymer #4 was prepared using the same procedure as Polymer #2, but the homogeneous mixture of ethylenic unsaturated monomers for Polymer #4 comprised 40% by weight of styrene, 39% by weight of MMA, 5% by weight of IBMA, and 16% by weight of MAA, each based on total weight of the monomers.

Tg of polymer was determined using differential scanning calorimetry (DSC) according to ASTM Method D3418-15. TABLE 1 showed Tg of Polymers #1 to #4.

TABLE 1

High Tg Polymer

| | #1 | #2 | #3 | #4 |
|---|---|---|---|---|
| Tg (° C.) | 126 | 101 | 102 | 105 |

### Example 2

Preparation of Floor Finishing Compositions

Each polymer was formulated with other ingredients, as shown in TABLE 2, to provide a floor finishing composition.

TABLE 2

| | | % by |
|---|---|---|
| Raw Material | Function | weight |
| Water | Diluent | 43.77% |
| Tested polymer | Polymer | 37.60% |
| Diethylene glycol n-propyl ether | Coalescing solvent | 4.00% |
| Diethylene glycol ethyl ether | Coalescing solvent | 3.00% |
| Ethylene glycol 2-ethylhexyl ether | Coalescing solvent | 1.00% |
| Capstone ™ FS-60 fluorosurfactant | Leveling agent | 0.04% |
| A-C ® 316 polyethylene wax emulsion | Slip modifier | 3.06% |
| Epolene ® E-43 polypropylene wax | Slip modifier | 2.73% |
| emulsion | | |
| Zinc ammonium carbonate solution | Crosslinking agent | 2.35% |
| Tributyoxylethyl phosphate | Plasticizer | 2.44% |
| BYK ®-024 | Defoamer | 0.01% |
| | | 100.00% |

The tested polymer was an emulsion polymer having a % solids content of 40%. Three coalescing solvents (DP, DE, and EEH) were used in the floor finishing composition at the level of 8% by weight based on total weight of the floor finishing composition. Capstone™ FS-60 fluorosurfactant was at 40% solids and available from DuPont Fluoropolymer Solutions. A-C® 316 polyethylene wax was an oxidized polyethylene wax at 35% solids commercially available from Honeywell Inc. Epolene® E-43 propylene wax was a maleated polypropylene wax at 40% solids commercially available from Eastman Chemical Company. Zinc ammonium carbonate solution was 35% active and prepared at 15% solids. BTK®-024 was a silicone-based defoamer at 100% active commercially available from BYK-Gardner GmbH.

### Example 3

Durability of Floor Finishing Compositions

High Tg Polymer #1 was formulated with other ingredients shown in TABLE 2 to provide the floor finishing composition #1F.

“Polymer A” was a polymer of ethylenic unsaturated monomers having a Tg of 75° C. as measured using DSC according to the ASTM Method D3418-15, wherein the ethylenic unsaturated monomers comprised methyl (meth)acrylate, α,β-unsaturated carboxylic acid, aromatic vinyl monomer, and 27% by weight of α,β-unsaturated carboxylic ester of C2-10 alcohol based on total weight of the monomers. Polymer A was formulated with other ingredients as shown in TABLE 2 to provide the floor finishing composition “Comparative A.”

“Polymer B” was DURAPLUS™ 3 emulsion commercially available from Dow Chemical Company, which was a modified acrylic polymer having a Tg of 82° C. as measured using DSC according to the ASTM Method D3418-15. At the date of the present disclosure, DURAPLUS™ 3 polymer has been known in the art as a high-performance polymer for use in floor finishing composition with high gloss and excellent durability. Polymer B was formulated with other ingredients as shown in TABLE 2 to provide the floor finishing composition “Comparative B.”

“Polymer C” was a polymer of ethylenic unsaturated monomers having a Tg of 103° C. as measured using DSC according to the ASTM Method D3418-15, wherein the ethylenic unsaturated monomers comprised methyl (meth)acrylate, aromatic vinyl monomer, α,β-unsaturated carboxylic acid, and 25% by weight of α,β-unsaturated carboxylic ester of C2-10 alcohol based on total weight of the monomers. Polymer C was formulated with other ingredients shown in TABLE 2 to provide the floor finishing composition “Comparative C.”

The durability of floor finishing composition was evaluated based on the development of gray color in the floor finish during its service life. Floor finishing composition #1F was tested for durability in comparison to “Comparative A”, “Comparative B”, and “Comparative C.”

The tested floor finishing composition was applied to the white vinyl composition tile (VCT) available from Armstrong Flooring, Inc. at a rate of 2 ml/ft² VCT surface, and allowed to dry for about one hour before a successive coat of the floor finishing composition was applied. After four coats of the floor finishing composition were applied to the VCT, the floor finished VCT substrate was placed in service for floor traffic testing.

The durability was evaluated by visual observation of gray color in the floor finished VCT. TABLE 3 showed a gray color rating of the VCT floor finished with the flooring finishing composition #1 compared to the VCT floors finished with Comparative A, Comparative B, or Comparative C. The “0” rating indicated that there was no gray color development after 103 days of foot traffic, while the “10” rating indicated the highest gray color development after 103 days of foot traffic.

TABLE 3

| | | Gray Color Rating |
|---|---|---|
| Floor Finishing | Tg of the | (0 = No gray color, |
| Composition | Polymer Used | 10 = Highly gray) |
| #1 | 126° C. | 0 |
| Comparative A | 75° C. | 4 |
| Comparative B | 82° C. | 10 |
| Comparative C | 103° C. | 0 |

As shown in TABLE 3, the floor finishing compositions #1 and Comparative C (derived from the polymers having Tg of 126° C. and 103° C., respectively) showed no development of gray color after 103 days of foot traffic. On the other hand, the floor finishing compositions Comparative A and Comparative B showed substantially higher development of gray color after 103 days of foot traffic.

### Example 4

Strippability of Floor Finishing Compositions

High Tg Polymers #2, #3, and #4 each were formulated with other ingredients as shown in TABLE 2 to provide the floor finishing compositions #2F, #3F, and #4F, respectively.

The strippability of each floor finishing composition was determined using the following procedure. The tested floor finishing composition was applied to the VCT tile at a rate of 2 ml/ft² and allowed to dry for 45 minutes at 68° F. and 40% relative humidity before applying the next coat of floor finishing composition.

On Day 1, two coats of the tested floor finishing composition were applied to the VCT tile to function as a base coat. After the base coat was dry to the touch, number “1” was written on the coatings with a white wax pencil. The third coat of floor finishing composition was applied on top of the base coat, allowed to dry, and the number “2” was written on the dried third coat. Then, three more coats of the floor finishing composition were successively applied, with the number “3”, “4”, or “5” written on top of each successive dried coating, respectively.

On Day 2, five more coats of the tested floor finishing composition were successively applied, with numbers “6”, “7”, “8”, “9”, and “10” written on top of each successive dried coating. Then, a last coat of the floor finishing composition was applied over the dried coat having the number “10” written thereon, respectively. The coated VCT tile was allowed to dry for two hours and then placed in a 100° F. chamber for two days.

On Day 4, the coated VCT tile was removed from the chamber and stored with the coated surface exposed to ambient air conditions.

On Day 7, the removal test was performed on the coated VCT tile with BYK Gardner Abrasion Tester using a diluted solution (1:20) of the PRO STRIP® SC floor stripper commercially available from Diversey, Inc. at 50 ml per sample, and a red floor buffing and cleaning pad commercially available from 3M Company. The removal of number “10” on the coated VCT tile indicated that one coat of the floor finishing composition was completely removed, and the number of cycles required to remove one coat of the floor finishing composition was recorded. Then, the removal of number “9” on the coated VCT tile indicated that two coats of the floor finishing composition were removed, and the number of cycles required to remove two coats was recorded. This removal process was continued until number “1” on the coated VCT tile was removed, indicating that 10 coats of the floor finishing composition were removed.

TABLE 4

| | #Cycles required to remove the coatings of floor finishing | | | | | | | | | |
|---|---|---|---|---|---|---|---|---|---|---|
| Floor | composition from Coated VCT tile | | | | | | | | | |
| Finishing | 1 | 2 | 3 | 4 | 5 | 6 | 7 | 8 | 9 | 10 |
| Composition | Coat | Coats | Coats | Coats | Coats | Coats | Coats | Coats | Coats | Coats |
| #2 | 37 | 53 | 94 | 110 | 150 | 166 | 205 | 231 | 252 | 288 |
| #3 | 39 | 66 | 155 | 192 | 240 | 302 | 344 | 389 | 424 | 470 |
| #4 | 13 | 27 | 64 | 88 | 113 | 123 | 145 | 153 | 190 | 235 |

TABLE 4 showed the number of cycles required for removing the coatings of floor finishing composition from the coated VCT tile. As shown, the floor finishing compositions #2, #3, and #4 were successfully removed using the conventional floor stripping process. The floor finishing compositions #2 and #4 showed superior strippability compared to the floor finishing composition #3.

### Example 5

Film Formation of Floor Finishing Compositions

Three test methods were used to determine the minimum amount of coalescing solvent required in the floor finishing composition to form a continuous film of floor finish on the substrate.

The floor finishing composition was prepared using similar ingredients as shown in TABLE 2, except that the amount of total coalescing solvents was varied to 5%, 6%, 7%, or 8% by weight based on total weight of the floor finishing composition.

The film formation of each floor finishing composition was observed visually, such as visual observation for streak, bloom, bronzing, solvent pop, etc. Based on the visual observation, the film formed from the floor finishing composition was rated into three categories:
“FAIL” for the film having unacceptably high levels of streaking, bloom, solvent pop, etc.;
“MARGINAL” for the film having some streak, bloom, solvent pop, etc.; and
“PASS” for a continuous film that was substantially free of streaking, bloom, solvent pop, etc.

Method 1. Single Coat

The tested floor finishing composition was cast on a glass slide (75×38×1 mm) at 1 ml wet coating and allowed for the film to develop at a surface temperature of 45° F., an air temperature of 70° F., and 25% relative humidity. The film derived from each tested floor finishing composition was evaluated for film formation property and rated as shown in TABLE 5.

Floor finishing compositions #2F, #3F, and #4F each required at least 7% by weight of total coalescing solvents based on total weight of the floor finishing composition to achieve a continuous film formation.

TABLE 5

| | |
|---|---|
| Floor Finishing | Amount of Coalescing Solvent ⁽*⁾ |

| Composition | 5% | 6% | 7% | 8% |
|---|---|---|---|---|
| #2F | FAIL | FAIL | PASS | PASS |
| #3F | FAIL | FAIL | PASS | PASS |
| #4F | FAIL | FAIL | PASS | PASS |

⁽*⁾ % by weight based on total weight the floor finishing composition

Method 2. Multiple Coats Simulating Real-World Installation

Method 2 simulated a real-world installation that required multiple coats of floor finishing composition to achieve the floor finish with a desirable level of floor protection and appearance. Six coats of the floor finishing composition were applied to black vinyl composition tile (VCT) available from Armstrong Flooring, Inc. A coat of the floor finishing composition was applied at a rate of 2 ml /ft² VCT surface and allowed to dry for about 20 minutes before applying the successive coat of floor finishing composition. The film of floor finishing composition on the VCT surface was allowed to develop at a surface temperature of 68° F., an air temperature of 70° F., and 35% relative humidity. The film derived from each tested floor finishing composition on the VCT surface was evaluated for film formation property and rated as shown in TABLE 6.

Floor finishing compositions #2F and #3F required between about 5% and about 6% by weight of total coalescing solvents based on total weight of the floor finishing composition to achieve continuous film formation. Floor finishing composition #4F required between about 7% and about 8% by weight of total coalescing solvents based on total weight of the floor finishing composition to achieve a continuous film formation.

TABLE 6

| | |
|---|---|
| Floor Finishing | Amount of Coalescing Solvent ⁽*⁾ |

| Composition | 5% | 6% | 7% | 8% |
|---|---|---|---|---|
| #2F | MARGINAL | PASS | PASS | PASS |
| #3F | MARGINAL | PASS | PASS | PASS |
| #4F | FAIL | FAIL | MARGINAL | PASS |

⁽*⁾ % by weight based on total weight the floor finishing composition

Method 3. Multiple Coats Simulating Real-World Installation During the Winter Season

Method 3 was to simulate a real-world installation during the winter season, particularly near an exterior entrance to a commercial or public building. Two coats of the floor finishing composition were applied to each black vinyl composition tile (VCT) available from Armstrong Flooring, Inc. A coat of the floor finishing composition was applied at a rate of 2 ml /ft² and allowed to dry for about one hour before applying the successive coat of floor finishing composition. The film of floor finishing composition on the VCT surface was allowed to develop at a surface temperature of 50° F., an air temperature of 50° F., and 25% relative humidity. The film derived from each tested floor finishing composition on the VCT surface was evaluated for film formation property and rated as shown in TABLE 7.

TABLE 7

| | |
|---|---|
| Floor Finishing | Amount of Coalescing Solvent ⁽*⁾ |

| Composition | 5% | 6% | 7% | 8% |
|---|---|---|---|---|
| #2F | FAIL | FAIL | FAIL | PASS |
| #3F | FAIL | FAIL | FAIL | PASS |
| #4F | FAIL | FAIL | FAIL | PASS |

⁽*⁾ % by weight based on total weight the floor finishing composition

Floor finishing compositions #2F, #3F, and #4F each required more than 8% by weight of total coalescing solvents based on total weight of the floor finishing composition to achieve a continuous film formation.

Various features and advantages of the invention are set forth in the following claims.

1. A floor finishing composition, comprising:
water;
polymer of ethylenic unsaturated monomers, wherein the polymer has a glass transition temperature of at least 105° C. and no more than 150° C. as measured using differential scanning calorimetry according to the ASTM Method D3418-15,
wherein the ethylenic unsaturated monomers comprise methyl (meth)acrylate, α,β-unsaturated carboxylic acid, aromatic vinyl monomer, and no more than 25% by weight of α,β-unsaturated carboxylic ester of C2-10 alcohol based on total weight of the monomers;
coalescing solvent; and
polyvalent metal crosslinking agent.

2. The composition of claim 1, wherein the ethylenic unsaturated monomers comprise from about 14% to about 18% by weight of the α,β-unsaturated carboxylic acid based on total weight of the monomers.

3. The composition of claim 1, wherein the ethylenic unsaturated monomers comprise less than 25% by weight of α,β-unsaturated carboxylic ester of C2-10 alcohol based on total weight of the monomers.

4. The composition of claim 1, wherein the α,β-unsaturated carboxylic acid comprises (meth)acrylic acid, maleic acid, fumaric acid, aconitic acid, crotonic acid, citraconic acid, acryloxypropionic acid, or any mixtures thereof.

5. The composition of claim 1, wherein the ethylenic unsaturated monomers comprise from about 15% to about 55% by weight of the methyl (meth)acrylate.

6. The composition of claim 1, wherein the ethylenic unsaturated monomers comprise from about 30% to about 50% by weight of the aromatic vinyl monomer based on total weight of the monomers.

7. The composition of claim 1, wherein the aromatic vinyl monomer comprises styrene, α-methylstyrene, β-methylstyrene, vinyl toluene, 1-vinyl naphthalene, 1-methylstyrene, 2-methylstyrene, 3-methylstyrene, 3,4-dimethylstyrene, 4-ethylstyrene, 2-chlorostyrene, 3-chlorostyrene, 1-bromostyrene, 2-bromostyrene, 4-chloro-3-methylstyrene, 4-t-butylstyrene, 2,4-dichlorostyrene, 2,6-dichlorostyrene, 1-methoxystyrene, 2-methoxystyrene, 4-methoxystyrene, allyl phenyl ether, allyl tolyl ether, or any mixtures thereof.

8. The composition of claim 1, wherein the α,β-unsaturated carboxylic ester of C2-10 alcohol comprises methyl (meth)acrylate, ethyl (meth)acrylate, n-propyl (meth)acrylate, iso-propyl (meth)acrylate, n-butyl (meth)acrylate, iso-butyl (meth)acrylate, t-butyl (meth)acrylate, n-amyl (meth)acrylate, iso-amyl (meth)acrylate, hexyl (meth)acrylate, cyclohexyl (meth)acrylate 2-ethyl hexyl (meth)acrylate, n-octyl methacrylate, iso-nonyl (meth)acrylate, decyl (meth)acrylate, or any mixtures thereof.

9. The composition of claim 1, wherein the ethylenic unsaturated monomers comprise:
from about 15% to about 55% by weight of the methyl (meth)acrylate;
from about 14% to about 16% by weight of the α,β-unsaturated carboxylic acid;
from about 30% to about 50% by weight of the aromatic vinyl monomer, and
no more than 25% by weight of the α,β-unsaturated carboxylic ester of C2-10 alcohol, all based on total weight of the monomers.

10. The composition of claim 1, wherein the coalescing solvent is present in an amount of at least 6% by weight based on total weight of the floor finishing composition.

11. The composition of claim 1, wherein the coalescing solvent fulfills at least one of the following:
(a) the coalescing solvent comprises alcohol, polyvalent alcohol, glycol ether, glycol ether esters, ester alcohols, or any mixtures thereof;
(b) the coalescing solvent comprises diethylene glycol monoethyl ether, diethylene glycol n-propyl ether, ethylene glycol 2-ethylhexyl ether, or any mixtures thereof.

12. The composition of claim 1, wherein the polyvalent metal crosslinking agent comprises zinc ammonium carbonate.

13. The composition of claim 1, wherein the polyvalent metal crosslinking agent is present in the range of from about 10% to about 100% theoretical mole stoichiometry based on the α,β-Unsaturated carboxylic acid monomer unit on the polymer.

14. The composition of claim 1, wherein the composition fulfills at least one of the following:
(a) the composition has a pH of from about 6 to about 10;
(b) the composition has a % solids content of from about 10% to about 30%;
(c) the composition further comprises plasticizer, alkaline soluble resin, wax, surfactant, dispersing agent, wetting agent, leveling agent, coating slip aid, defoamer, preservative, biocide, or any combinations thereof.

15. A method of finishing a floor, comprising applying the floor finishing composition of claim 1, to the floor surface.

16. A method of using a polymer having a glass transition temperature of at least 105° C. and no more than 150° C. in floor finishing composition, wherein the glass transition temperature is measured using differential scanning calorimetry according to the ASTM Method D3418-15, and
wherein the polymer includes units derived from ethylenic unsaturated monomers comprising methyl (meth)acrylate, α,β-unsaturated carboxylic acid, aromatic vinyl monomer, and no more than 25% by weight of α,β-unsaturated carboxylic ester of C2-10 alcohol based on total weight of the monomers.

17. The method of claim 16, wherein the ethylenic unsaturated monomers fulfills at least one of the following:
(a) the monomers comprise from about 14% to about 18% by weight of the α,β-unsaturated carboxylic acid based on total weight of the monomers;
(b) the monomers comprise less than 25% by weight of α,β-unsaturated carboxylic ester of C2-10 alcohol based on total weight of the monomers;
(c) the monomers comprise from about 30% to about 50% by weight of the aromatic vinyl monomer based on total weight of the monomers;
(d) the monomers comprise from about 15% to about 55% by weight of the methyl (meth)acrylate.

18. The method of claim 16, wherein the α,β-unsaturated carboxylic acid comprises (meth)acrylic acid, maleic acid, fumaric acid, aconitic acid, crotonic acid, citraconic acid, acryloxypropionic acid, or any mixtures thereof.

19. The method of claim 16, wherein the aromatic vinyl monomer comprises styrene, α-methylstyrene, β-methylstyrene, vinyl toluene, 1-vinyl naphthalene, 1-methylstyrene, 2-methylstyrene, 3-methylstyrene, 3,4-dimethylstyrene, 4-ethylstyrene, 2-chlorostyrene, 3-chlorostyrene, 1-bromostyrene, 2-bromostyrene, 4-chloro-3-methylstyrene, 4-t-butylstyrene, 2,4-dichlorostyrene, 2,6-dichlorostyrene, 1-methoxystyrene, 2-methoxystyrene, 4-methoxystyrene, allyl phenyl ether, allyl tolyl ether, or any mixtures thereof.

20. The method of claim 16, wherein the α,β-unsaturated carboxylic ester of C2-10 alcohol comprises methyl (meth)acrylate, ethyl (meth)acrylate, n-propyl (meth)acrylate, iso-propyl (meth)acrylate, n-butyl (meth)acrylate, iso-butyl (meth)acrylate, t-butyl (meth)acrylate, n-amyl (meth)acrylate, iso-amyl (meth)acrylate, hexyl (meth)acrylate, cyclohexyl (meth)acrylate 2-ethyl hexyl (meth)acrylate, n-octyl methacrylate, iso-nonyl (meth)acrylate, decyl (meth)acrylate, or any mixtures thereof.

21. (canceled)
